(19) United States
(12) Patent Application Publication
(10) Pub. No.: US 2020/0398726 A1
(43) Pub. Date: Dec. 24, 2020

(54) BEVERAGE HOLDER

(71) Applicant: Edward Frye, Indianapolis, IN (US)

(72) Inventors: Edward Frye, Indianapolis, IN (US); Ethan Cating, Fortville, IN (US)

(21) Appl. No.: 16/888,754

(22) Filed: May 31, 2020

Related U.S. Application Data
(60) Provisional application No. 62/855,029, filed on May 31, 2019.

(51) Int. Cl. B60N 3/10; F16F 15/22

(52) U.S. Cl. CPC B60N 3/103; F16F 15/22

(57) ABSTRACT

A beverage holder is configured to receive a liquid container. The beverage holder comprises a gyroscope including a frame member, an outer gimbal and an inner gimbal. A beverage retainer is coupled to the inner gimbal of the gyroscope, the beverage retainer designed and dimensioned to secure the liquid container therein. A vehicle mount is arranged below the gyroscope and configured to move relative to the gyroscope. A suspension couples the gyroscope to the vehicle mount, the suspension including a spring arrangement permitting linear movement between the gyroscope and the vehicle mount. A tuned mass damper couples to the gyroscope to reduce linear movement of the gyroscope.

### CROSS-REFERENCE TO RELATED APPLICATIONS

This application claims priority to U.S. provisional patent application Ser. No. 62/855,029, filed May 31, 2019, the entire contents of which are incorporated herein by reference.

### FIELD

This application relates to the field of liquid retaining devices and particularly to devices configured to hold beverages within containers.

### BACKGROUND

Vehicles, including cars, trucks, boats, planes, tractors, riding lawnmowers, etc. include cup holders. These cup holders are typically provided by simple cavities that are designed and dimensioned to receive a cup, bottle, can, insulated container, or other type of liquid container. While typical cup holders are capable of keeping many containers upright, problems exist with these cup holders during operation of the vehicle. In particular, vehicle operation imparts various forces on the containers and the associated beverages within the cup holders. These forces include acceleration forces, braking forces, centripetal forces, shaking, vibration, etc., and result in sloshing and aggravation of the beverage within the associated container. When these forces are significant enough, liquid may spill out of the container. Moreover, when the liquid in the container is a carbonated beverage, the shaking and sloshing of the liquid causes the carbon to be released, resulting in a flat beverage that is undesirable for consumption. Accordingly, it would be beneficial to provide a beverage holder that may be used to reduce the shaking and sloshing of liquids when riding in a vehicle. It would also be beneficial for the beverage holder to be adaptable and configured for use with existing cup holders within vehicles. Furthermore, it would be beneficial for the beverage holder to hold numerous different types of containers while allowing the containers to be easily inserted into and removed from the beverage holder.

### SUMMARY

A beverage holder is configured to receive a liquid container. The beverage holder comprises a gyroscope including a frame member, an outer gimbal and an inner gimbal. A beverage retainer is coupled to the inner gimbal of the gyroscope, the beverage retainer designed and dimensioned to secure the liquid container therein. A vehicle mount is arranged below the gyroscope and configured to move relative to the gyroscope. A suspension couples the gyroscope to the vehicle mount. The suspension includes a spring arrangement that permits movement between the gyroscope and the vehicle mount.

In at least one embodiment, a beverage holder includes a gyroscope, a beverage retainer, a vehicle mount, and a suspension. The gyroscope includes a support member, an outer gimbal and an inner gimbal. The outer gimbal is pivotably coupled to the support member, and the inner gimbal is pivotably connected to the outer gimbal. The beverage retainer is coupled to the inner gimbal of the gyroscope and is designed and dimensioned to secure the liquid container therein. The vehicle mount includes a substantially cylindrical portion designed and dimensioned for insertion into a vehicle cup holder. The suspension provides a moveable coupling that permits axial movement between the gyroscope support member and the vehicle mount.

In at least one embodiment, the beverage holder includes a housing, a suspension, a gyroscope, and a beverage retainer. The housing includes an upper housing and a lower housing. The upper housing includes an opening designed and dimensioned to receive the liquid container. The lower housing is designed and dimensioned to fit within a vehicle cup holder. The upper housing defines a greater volume than the lower housing. The suspension is positioned within the upper housing and includes a plurality of rods, a plurality of springs coupled to the plurality of rods, and a support slideably coupled to the plurality of rods. The support is biased by the plurality of springs and configured to move along the plurality of rods in an axial direction. The gyroscope is also positioned within the upper housing and coupled to the support of the mass damper. The gyroscope includes an outer gimbal rotatably attached to an inner gimbal. The beverage retainer is coupled to the inner gimbal within the upper housing. The beverage retainer is configured to receive and retain the liquid container.

The above described features and advantages, as well as others, will become more readily apparent to those of ordinary skill in the art by reference to the following detailed description and accompanying drawings. While it would be desirable to provide a beverage holder that provides one or more of these or other advantageous features, the teachings disclosed herein extend to those embodiments which fall within the scope of the appended claims, regardless of whether they accomplish one or more of the above-mentioned advantages.

### BRIEF DESCRIPTION OF THE DRAWINGS

FIG. 1 shows a upper perspective view of a beverage holder with a liquid container positioned therein;

FIG. 2 shows a side perspective view of the beverage holder of FIG. 1 with the walls of the upper canister shown in transparency to expose the gyroscope, beverage retainer and canister floor;

FIG. 3 shows cross-sectional perspective view of the beverage holder of FIG. 1 with the walls of the upper canister and walls of the lower cup shown in transparency to expose the canister floor and center tube of the upper canister as well as the center post of the lower cup;

FIG. 4 shows a lower perspective view of the beverage holder of FIG. 1 with the cup walls of the lower cup removed to expose the spring plates of the mass damper that extend between the walls of the lower cup and the center tube of the upper canister;

FIG. 5 shows a plan view of one of the spring plates of FIG. 1;

FIG. 6 shows a top view of the spring plate of FIG. 5 arranged between the walls of the lower cup and the center tube of the upper canister;

FIG. 7A shows a plan view of an alternative embodiment of the spring plate of FIG. 5;

FIG. 7B shows a perspective view of the spring plate of FIG. 7A in a deflected position;

FIG. 8 shows a side view of an alternative embodiment of the beverage holder of FIG. 1 with an outer shell removed to expose an interior of an upper housing including a framework and gyroscope;

FIG. 9 shows a lower perspective view of the framework and gyroscope of FIG. 8;

FIG. 10 shows a top view of the beverage holder of FIG. 8 through a hole in an upper housing of the beverage holder;

FIG. 11 shows a side view an alternative embodiment of the beverage holder of FIG. 8 with an outer shell removed to expose an interior of an upper housing including a framework and gyroscope;

FIG. 12 shows a top perspective view of the beverage holder of FIG. 11 with the outer shell included;

FIG. 13 shows a bottom perspective view of an alternative embodiment of the beverage holder of FIG. 8, wherein the lower housing includes a conical shape and a rib member;

FIG. 14 shows a bottom perspective view of an alternative embodiment of the beverage holder of FIG. 8 wherein the upper housing is moveable relative to the lower housing;

FIG. 15 shows a side view of yet another alternative embodiment of the beverage holder of FIG. 8 with an outer shell of the upper housing removed and a suspension positioned between the upper housing and the base; and

FIG. 16 shows a top perspective view of the beverage holder of FIG. 15 with the outer shell included on the upper housing.

### DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles of the disclosure as may normally occur to one skilled in the art which this disclosure pertains.

In the following description, reference is made to the accompanying drawings which form a part hereof wherein like numerals designate like parts throughout, and in which is shown, by way of illustration, embodiments that may be practiced. It is to be understood that other embodiments may be utilized, and structural or logical changes may be made without departing from the scope of the present disclosure. Therefore, the following description is not to be taken in a limiting sense, and the scope of embodiments is defined by the appended claims and their equivalents.

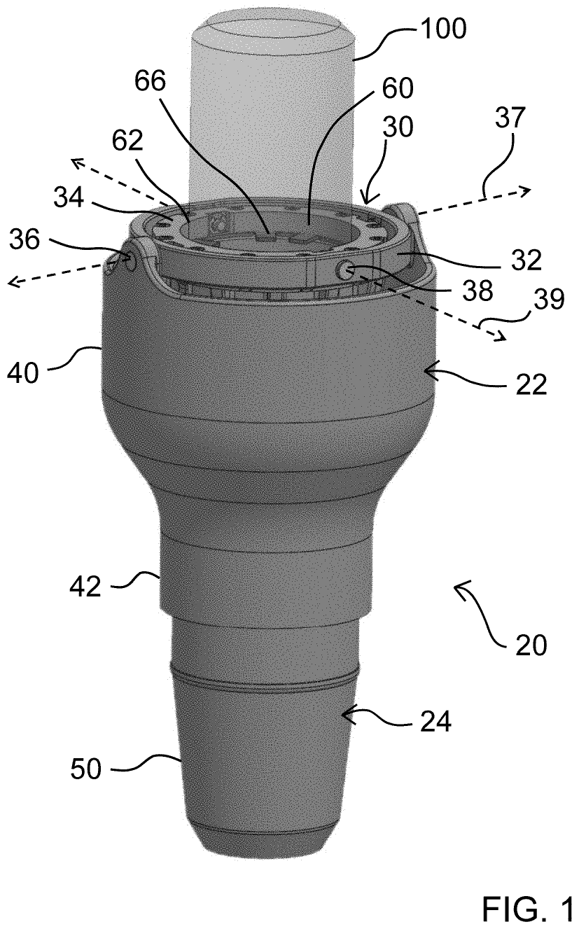

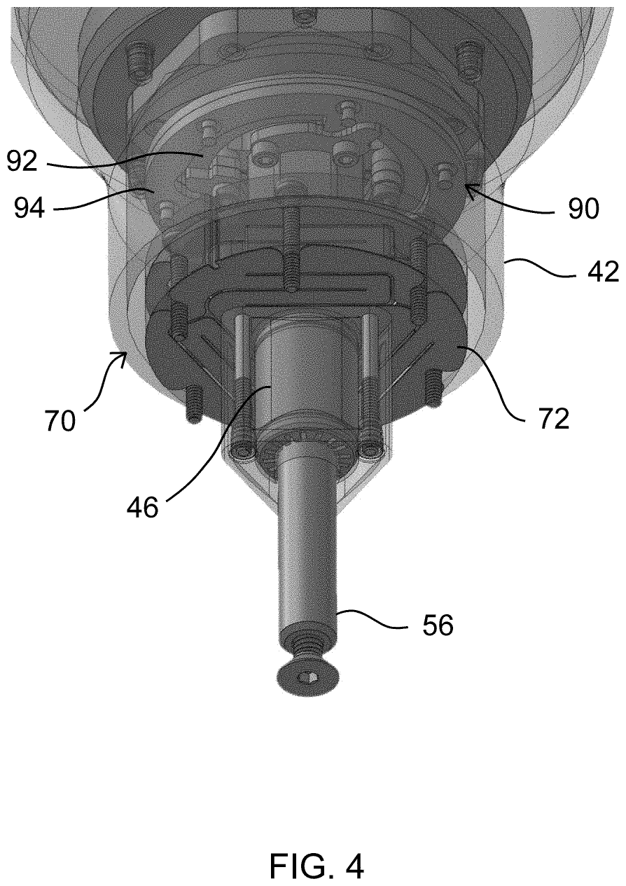

With reference now to FIGS. 1-6, a first embodiment of a beverage holder 20 is shown. The beverage holder 20 includes an upper housing 22 and a lower housing 24. The upper housing 22 includes an opening that provides access to a beverage retainer 60 that is designed and dimensioned to receive a liquid container 100 such as a bottle, can, cup, or other container. The beverage retainer 60 is coupled to a gyroscope 30 that is suspended within the upper housing 22. The gyroscope 30 is coupled to a suspension 70 that is configured to provide a cushioning effect for the gyroscope. The upper housing 22 is supported by and moveable with respect to the lower housing 24. The lower housing 24 is designed and dimensioned to be inserted into a vehicle cup holder.

The upper housing 22 of the beverage holder 20 is best shown in FIGS. 1-3. The upper housing 22 provides a canister, support, or other frame structure which supports the gyroscope 30. In the embodiment of FIGS. 1-6, the upper housing 22 includes canister walls 40, a lower skirt 42, a canister floor 44, and a center tube 46. The canister walls 40 are circular and result in a cylindrical structure. The diameter of the canister walls 40 is sufficiently large to allow the gyroscope 30 to be positioned therein. For example, the diameter of the canister walls may be between about 10 cm and 16 cm, depending on the size of the gyroscope 30. Also, the canister walls 40 are of sufficient height to allow a beverage held by the beverage retainer to extend down into the upper housing 22 and pivot within the upper housing 22. In at least one embodiment, the height of the canister walls 40 is between 10 cm and 20 cm.

The lower skirt 42 is also cylindrical in structure and serves as an extension of the canister walls 40 below the canister floor 44. The lower end of the canister walls 40 taper inwardly into the lower skirt 42. Accordingly, the diameter of the lower skirt 42 is less than that of the canister walls 40. In at least one embodiment, the diameter of the lower skirt 42 is between 7 cm and 11 cm.

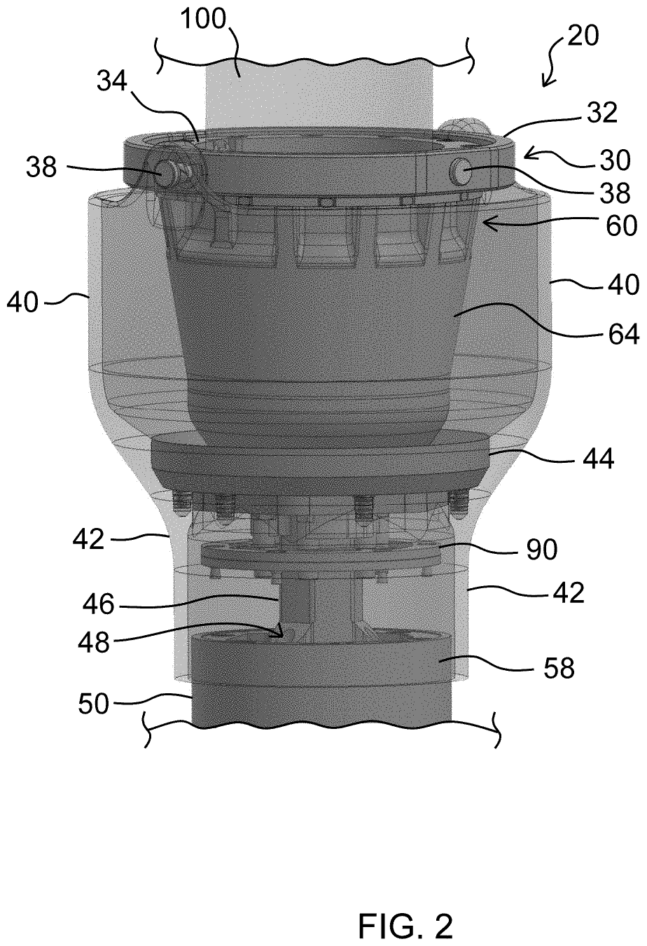

As best shown in FIG. 2, the canister floor 44 extends completely across the interior of the upper housing at the position where the canister walls 40 tapers inwardly toward the lower skirt 42. The canister floor 44 is saucer shaped such that a center of the canister floor 44 is somewhat depressed and sits lower than the edges of the canister floor. The canister floor 44 is positioned a sufficient distance away from the beverage retainer 60 to allow the beverage retainer and/or any beverage positioned therein to pivot without bumping into or otherwise contacting any of the components of the upper housing 22. The center depression in the canister floor 44 provides additional clearance to avoid any such contact.

The canister floor 44, canister walls 40, and lower skirt, are all connected together and fixed relative to one another. In at least one embodiment, the canister floor 44, canister walls 40, and lower skirt 42 are all one monolithic part formed from any of various known manufacturing processes such as injection molding or 3D printing. The upper housing 22 is generally comprised of a relatively strong and rigid thermoplastic polymer material, such as polyvinylchloride. In alternative embodiments, the upper housing may be comprised of a metal material, such as aluminum or even steel. It will be recognized that other components described herein, including the lower housing 24, gyroscope 30, and related components, are comprised of similar materials, such a plastic or metal materials, as will be recognized by those of skill in the art as being appropriate for their intended function.

The center tube 46 is fixed to and extends downwardly from the center of the canister floor 44. The center tube 46 includes an inner diameter configured to receive the post 56 of the lower housing 24, as described in further detail below. The center tube 46 may be provided in several sections, such as an upper section 46a, a middle section 46b, and a bottom section 46c. As explained in further detail below, suspension elements 70a and 70b may be secured to the bottom of the canister floor 44 or center tube 46 between each of the sections. Additionally, a tuned mass damper 90 may also be secured to the bottom of the canister floor 44 or center tube 46.

As best shown in FIGS. 1 and 2, a gyroscope 30 is mounted in the upper housing 22. The upper canister walls 40 provide a frame for the gyroscope 30. The gyroscope 30 further includes an outer gimbal 32 and an inner gimbal 34. The outer gimbal 32 is rotatably coupled to two supports 36 provided on the canister walls 40. The outer gimbal 32 is configured to rotate about a first axis of rotation 37 extending through the center of the two supports 36. The inner gimbal 34 is rotatably coupled to two supports 38 provided on the outer gimbal 32. The inner gimbal 34 is configured to rotate about a second axis of rotation 39 extending through the supports 38 on the outer gimbal 32. The second axis of rotation 39 is perpendicular to the first axis of rotation 37.

The beverage retainer 60 is coupled to and supported by the inner gimbal 32. In the embodiment of FIGS. 1-6, the beverage retainer 60 includes a mouth 62, teeth 66, and a body 64. The mouth 62 (as best shown in FIG. 1) is defined by the inner gimbal 32 and designed and dimensioned to receive a standard beverage bottle, can, cup or other liquid container for a beverage (i.e., a liquid container that is designed and configured for drinking directly therefrom). Accordingly, the mouth 62 is circular in shape and defined by a diameter between 6 cm and 10 cm, and in at least one embodiment between 7 cm and 8 cm. A plurality of resilient plastic teeth 66 extend inwardly from the inner diameter of the mouth 62. The resilient plastic teeth 66 are configured to deflect downwardly when a liquid container 100 is inserted into the mouth 62 and apply a force to the sides of the container in order to keep the container stable and avoid movement of the container relative to the beverage retainer 60. When the liquid container 100 is removed from the mouth 62, the teeth 66 return to an inwardly extending position.

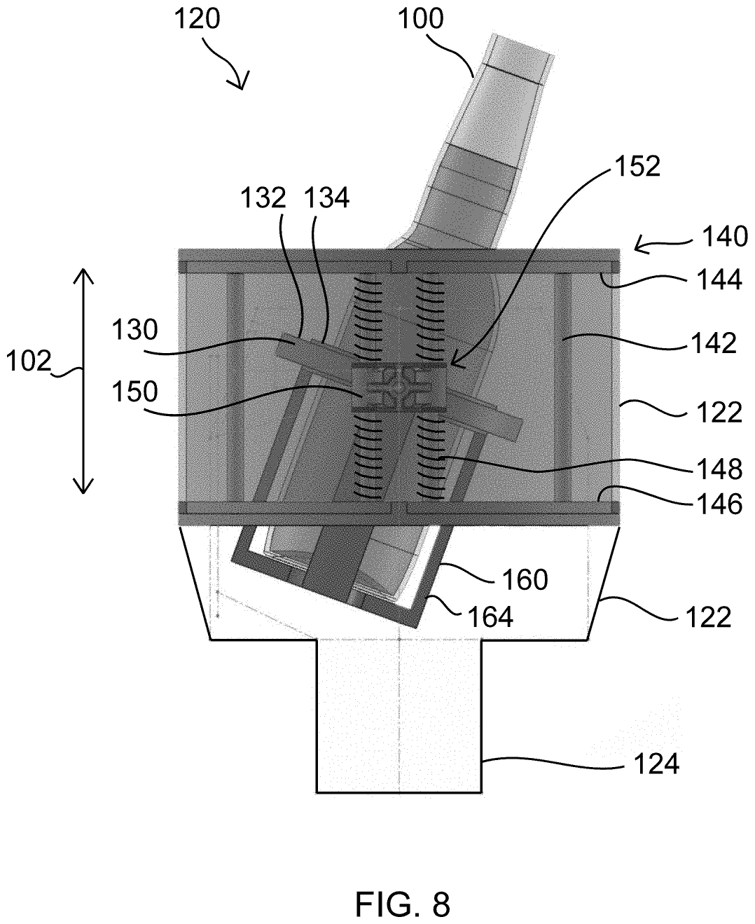

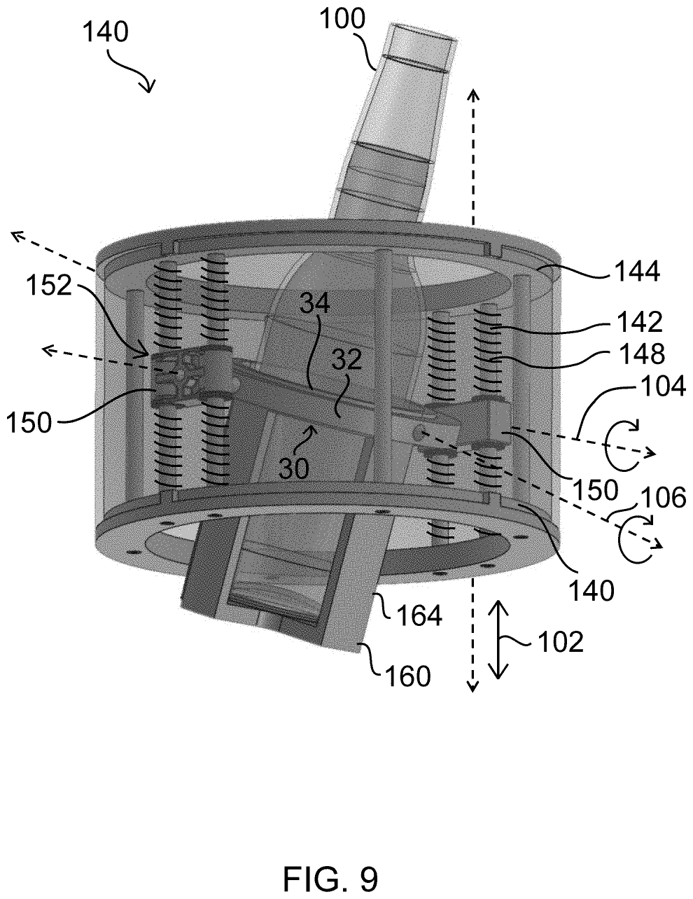

The body 64 of the beverage retainer 60 may be provided in various forms, such as a bowl structure (as shown in FIGS. 1-6) or a cage structure (as shown in FIGS. 8-9). The body 64 extends generally downward from the mouth 62/inner gimbal 34. The body is configured to support the weight of the liquid container 100. As noted above, a plurality of adjustable reinforcement structures, such as teeth 66, may be positioned around the mouth 62 and/or the body 64 and configured to abut the liquid container 100 that is inserted into the beverage retainer 60, thereby supporting the liquid container and helping to keep the liquid container securely held within the beverage retainer 60. In at least some embodiments, the reinforcement structures may be provided by foam pads, spring biased braces, or any of various other structures in addition to or in lieu of the teeth 66, as will be recognized by those of ordinary skill in the art.

With particular reference now to FIGS. 1, 3 and 4, the lower housing 24 of the beverage holder provides a vehicle mount for the beverage holder 20. In the embodiments disclosed herein, the lower housing 24 provides a vehicle mount in the form of a cup structure configured to fit within a vehicle cup holder. The lower housing 24 includes cup walls 50, an interior chamber 52, a bottom 54, a center post 56, and an upper rim 58.

The cup walls 50 of the lower housing 24 are generally cylindrical in shape and include an outer diameter that is sufficient to be retained within and securely held by a conventional cup holder for a car, boat, or other vehicle. Because conventional cup holders typically include an inner diameter between 5 cm and 12 cm, the cup walls have an outer diameter that is similarly between 5 cm and 12 cm. As a result, the cup walls 50 of the lower housing may be inserted into and retained within conventional vehicle cup holders. This is further true of conventional cup holders with adjustable holding features. However, it will be recognized that in different embodiments, the beverage holder 20 may have differently sized cup walls 50 in different embodiments, which may be better suited for different vehicles or other applications. For example, some embodiments may be configured for use with cup holders in land vehicles while other embodiments may be configured for use with cup holders in aircraft.

The inner diameter of the cup walls 50 is greater at the upper rim 58 than in the more centrally located portions of the cup walls 50. Accordingly, a shoulder is defined on the cup walls where the upper rim 58 begins. As explained in further detail below, this shoulder is configured to retain the suspension 70.

The cup walls 50 extend a height of about 5 cm to 12 cm between the upper rim 58 and the bottom 54. The bottom 54 provides a floor for the lower housing 24. In at least one embodiment, the cup walls 50 may taper inwardly near the bottom in order to assist a user in more easily inserting the lower housing 24 into a cup holder. The cup walls 50 define the interior chamber 52 between the upper rim 58 and the bottom 54.

The center post 56 is a solid cylindrical member that extends upwardly from the bottom 54 and through the interior chamber 52. In the embodiment disclosed herein, the center post 56 is fixedly secured to the bottom 54 of the lower housing 24 with a screw or other fastener. The center post 56 extends upward from the bottom 54 and past the upper rim 58 of the cup walls 50, and thus extends completely out of the interior chamber 52. The center post 56 has a diameter that allows it to fit closely inside of the center tube 46 that extends downwardly on the upper housing 22. The close fit between the center post 56 and the center tube 46 is such that the center post 56 provides stability for the center tube 46, preventing the center tube and the associated upper housing 22 from pivoting greatly with respect to the lower post (e.g., less than 5°). At the same time, sufficient clearance exists between the center tube 46 and the center post 56 to allow the center tube 46 to slide relative to the center post 56 in a linear direction defined by the center post 56. Accordingly, the center post 56 and center tube 46 act as a linear bearing that permits linear motion of the suspension upper housing 22 and the gyroscope 30 relative to the lower housing 24.

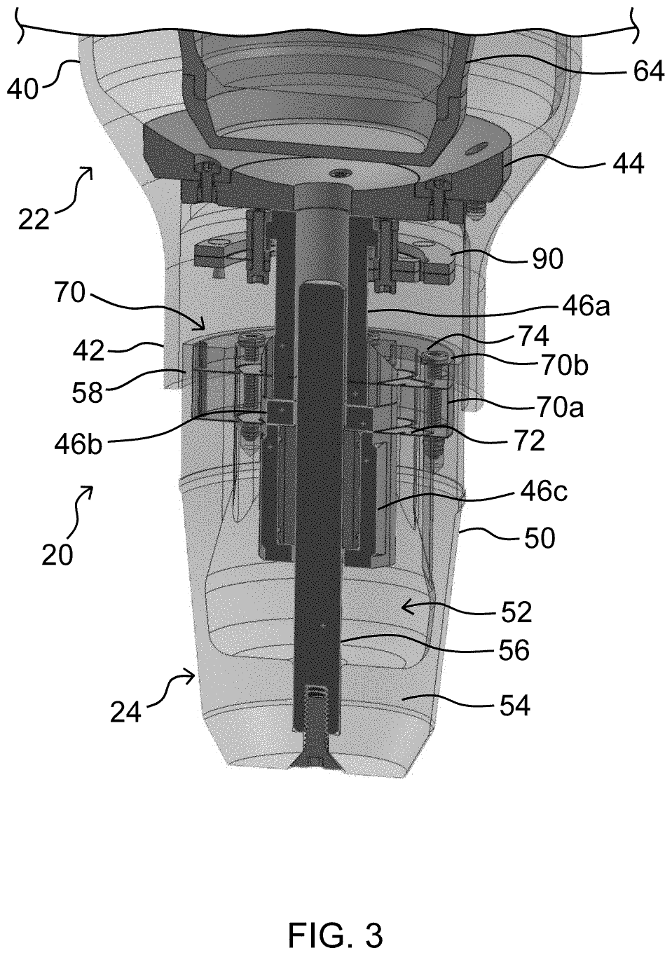

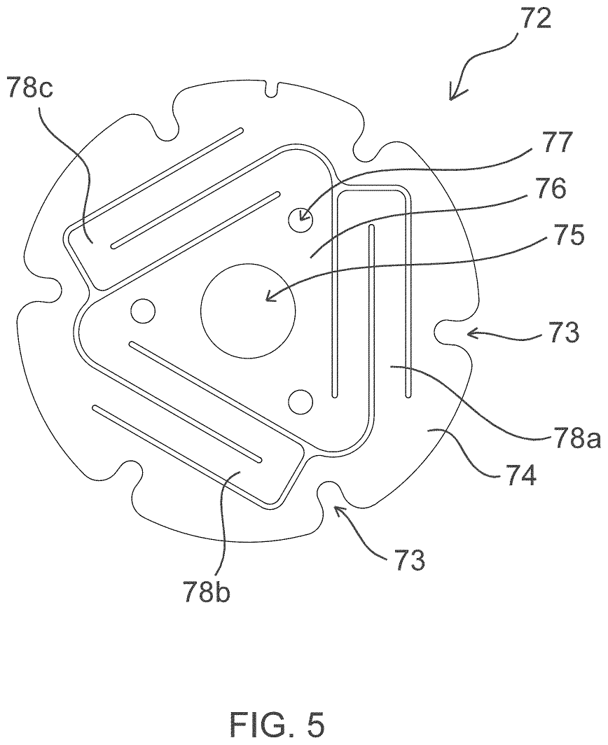

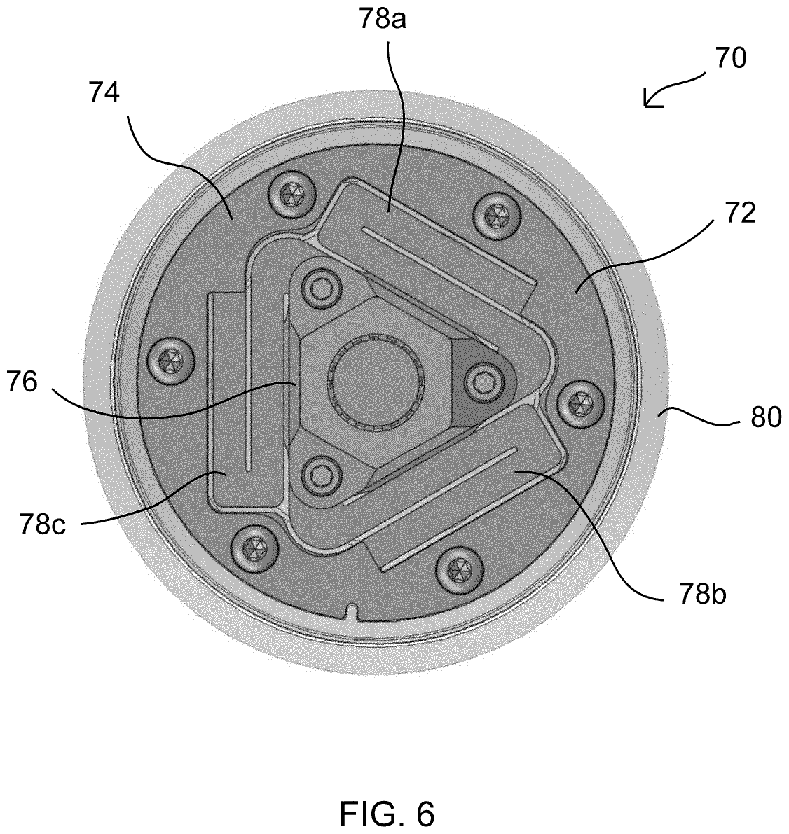

With particular reference now to FIGS. 3-6, in at least one embodiment, the suspension 70 includes one or more suspension elements 70a and 70b positioned between the upper rim 58 of the lower housing 24 and the center tube 46 of the upper housing 22. In this embodiment, each suspension element 70a and 70b includes a spring plate 72 secured within an outer disk 80. The spring plate 72 is a flat plate of metal with multiple cuts, stampings, channels, or other apertures formed therein. As best shown in FIGS. 5 and 6, each spring plate 72 includes an outer rim 74, an inner rack 76, and three flat springs 78 extending between the outer rim 74 and the inner rack 76.

The outer rim 74 of the spring plate 72 is generally circular in shape and includes a plurality of fastener recesses 73 configured to receive screws or other fasteners that secure the outer rim 74 to outer disk 80 and lower housing 24. In at least one embodiment, the outer disk 80 comprises two discs, including an upper disk and a lower disk, and the outer rim 74 of the spring plate 72 is sandwiched between the upper disk and the lower disk. The outer disk 80 (or disks) is fixedly positioned within the upper rim 58 of the lower housing 24, and thus secures the outer rim 74 of the spring plate 72 to the lower housing 24.

The inner rack 76 of the spring plate 72 is generally triangular in shape and includes a center passage 75 and three fastener holes 77. The center passage 75 is aligned with and the same size as the inner diameter of the center tube 46. Accordingly, the center post 56 is configured to extend through the center passage 75 of the spring plate 72, as best shown in FIG. 6. Each of the three fastener holes 77 on the inner rack 76 is positioned at an apex of the triangular inner rack 76 and configured to receive screws or other fasteners that secure the inner rack 76 to the center tube 46 and thus the upper housing 22. To this end, the center tube 46 includes a plurality of receptacles 48 that are aligned with the fastener holes 77 and receive fasteners that secure the center tube 46 to the inner rack 76 of the spring plate 72. As noted previously, the center tube 46 may be provided in multiple sections 46a, 46b, 46c (see FIG. 3). Accordingly, when multiple suspension elements are used (such as suspension elements 70a and 70b as shown in FIG. 3), the different sections of the center tube 46 may be positioned above and below the mass dampers, thus sandwiching the inner rack 76 of each spring plate between sections of center tube 46.

As best shown in FIGS. 5 and 6, three flat springs 78 are provided on each spring plate 72. Each flat spring 78 is U-shaped and includes a first end connected to the outer rim 74 and a second end connected to one of the apexes of the triangular inner rack 76. An axial force applied to either end of the flat spring 78 results in deflection of the spring such that one end is moved in an axial direction (as defined by the center post 56) relative to the opposite end. Accordingly, each flat spring allows the inner rack 76 (and the connected center tube 46 of the upper housing 22) to move in an axial direction relative to the outer rim 74 (and the connected cup walls 50 of the lower housing 24. The flat springs 78 not only permit linear movement between the upper housing 22 and the lower housing 24, but also bias the upper housing 22 toward an equilibrium position relative to the lower housing as the force of gravity acts on the upper housing 22, the lower housing 24, and the suspension 70. Movement between the outer rim 74 and the inner rack 76 (and thus the lower housing 24 and upper housing 22) is permitted by the spring plate 72, but limited, as increasing forces are required to incrementally deflect the flat springs 78 further and further. As a result, the spring plate 72 is configured to dampen movement of the upper housing 22 relative to the lower housing 24 and generally provide a cushioning effect such that forces encountered by the lower housing 24 are not fully transferred to the upper housing 22.

As noted previously, the beverage container may include more than one suspension element. In the embodiment, of FIGS. 1-6, two suspension elements, including an upper suspension element 70b and a lower suspension element 70a (see best shown in FIG. 3). Suspension elements 70a and 70b are stacked on top of one another and are directly coupled to the upper rim 58 of the lower housing 24. Suspension elements 70a and 70b are also provided with spring plates 72 as shown in FIG. 6. However, it will be recognized that the suspension and suspension elements may take different forms, such as suspension elements with different types of springs or spring plates, or different connections between various components in order to limit movement of the gyroscope, such as that shown in the embodiments of FIGS. 8-16, described in further detail below.

In addition to the suspension elements 70a and 70b, the suspension may also include a tuned mass damper 90. Like the suspension elements 70a and 70b, the tuned mass damper also includes a spring plate 92 and an outer disk 94. However, as shown in FIGS. 2-4, the mass damper 90 includes a different spring configuration and a different connection to the lower housing than that of suspension elements 70a and 70b. In particular, mass damper 90 is connected to the lower housing 24 via a connection to the suspension elements 70a and 70b using screws, posts, or other fasteners (now shown). Thus, unlike the suspension elements 70a and 70b, the mass damper 90 is not directly coupled to the upper rim 58 of the lower housing. Furthermore, while the spring configuration of the mass damper 90 is a flat spring, it is more of an S-shape than a U-shape. The tuned mass damper 90 is specifically configured such that the mass and spring rate are such to match the first natural frequency of the upper housing 22 and gyroscope 30. At that frequency the lower housing 24 will move opposite the upper housing 22 and gyroscope 30 to reduce the amplitude of movement of a beverage held in the beverage retainer 60, thus reducing the impact of vibration and impacts from the vehicle to the liquid in the beverage. While the gyroscope 30 and suspension elements 70a and 70b could also be considered a mass damper of sorts, they have less amplitude and frequency of movement than the mass damper 90. In other words, the mass damper 90 is distinguished from the suspension elements 70a and 70b because the springs in the spring plate 92 of the mass damper 90 have a significantly greater amplitude and frequency of movement than those in the suspension elements 70a and 70b.

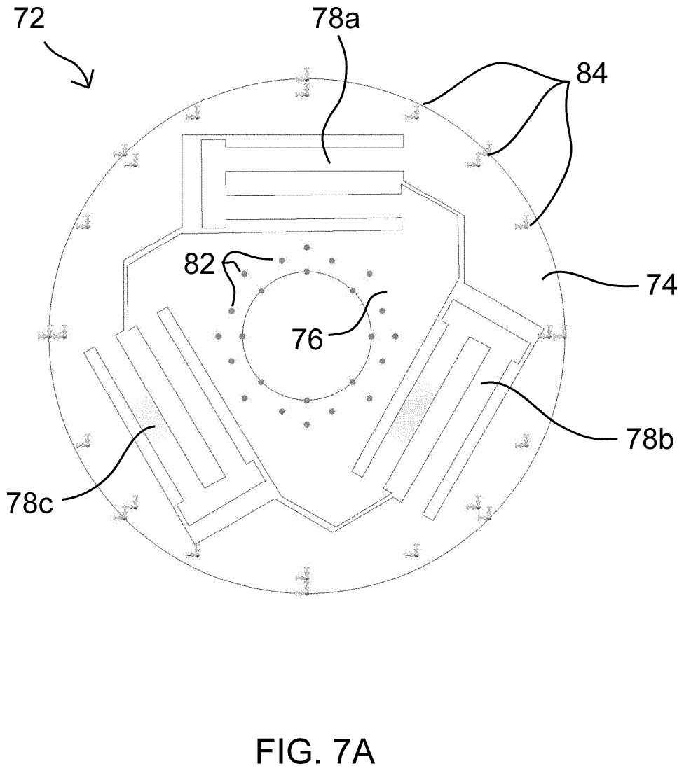

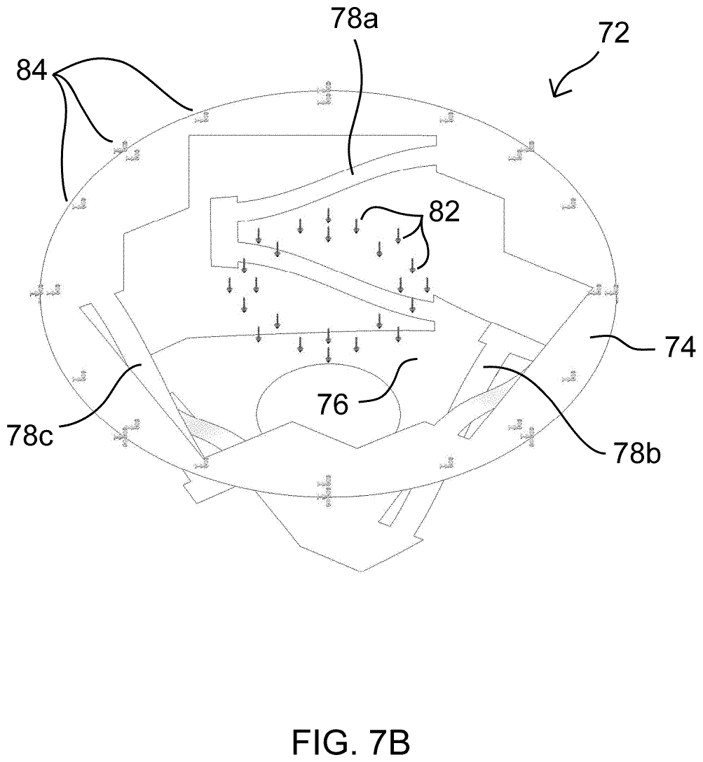

With reference now to FIGS. 7A and 7B, an illustration of the movement of the spring plate 72 for the suspension 70 is shown. Similar to the suspension elements 70a and 70b in the embodiment of FIGS. 1-6, the spring plate 72 in FIGS. 7A and 7B includes three U-shaped flat springs 78a, 78b, and 78c extending between an outer rim 74 and an inner rack 76. When an axial force is applied to the inner rack 76 (as noted by axial arrow icons 82), the inner rack 76 is moved in the axial direction, and the flat springs 78a, 78b, and 78c deflect. Deflection of the flat springs transfers the axial forces applied to the inner rack 76 in the axial, radial and circumferential directions on the outer rim 74, as noted by arrow icons 84. Thus, much of the axial energy applied to the inner rack 76 is dissipated and translated by deflection of the flat springs 78a, 78b and 78c, resulting in a relatively small axial force being distributed to the outer rim 74. Because of this, the spring plate 72 is configured to provide a cushioning effect when the inner rack 76 experiences axial forces and is moved relative to the outer rim 74, or vice-versa when the outer rim experiences axial forces and is moved relative to the inner rack. Because the outer rim 74 of the spring plate 72 is connected to the lower housing 24, and the inner rack 76 of the spring plate 72 is connected to the upper housing 22, the result is a cushioning effect between the upper housing 22 and the lower housing 24 when axial forces are applied to either the upper housing 22 or the lower housing 24. While there is a small amount of solid layer damping that occurs within the metal springs as they move, the primary function of the springs is to store and release mechanical energy when extending or retracting during movement. The springs of the suspension 70 and mass damper 90 will work against each other and with mechanical losses and the constant force of gravity will settle the gyroscope and housing back to an equilibrium position.

In operation, the beverage holder 20 is used to reduce the transmission of forces from a vehicle to a beverage retained within the beverage holder 20. To accomplish this, the lower housing 24 of the beverage holder 20 is inserted into a cup holder of a vehicle. Thereafter, a liquid container 100, such as a bottle or can containing a user's carbonated beverage, is inserted into the hole in the top of the upper housing 22 and into the beverage retainer 60. When the vehicle is operated, forces applied by the vehicle are absorbed in large part by the lower housing 24 and the beverage holder 20. In particular, the suspension 70 absorbs much of the linear energy of the lower housing 24 and significantly lessens transmission of such linear forces to the upper housing 22 and the liquid container 100 positioned therein. At the same time, the gyroscope 30 pivots relative to the upper housing 22 and lower housing 24 and maintains the liquid container 100 in an upright position, thereby limiting transmission of other forces (e.g., yaw, roll, pitch) to the liquid container. As a result, the liquid within the liquid container 100 does not slosh around and spill out of the container to the same extent that would be encountered without the beverage holder. Moreover, if the beverage is carbonated, the liquid is not aggravated to the extent that the liquid loses its carbonation.

With reference now to FIGS. 8-10, an alternative embodiment of a beverage holder 120 is shown. The beverage holder 120 includes an upper housing 122 and a lower housing 124. The upper housing 122 includes an opening that provides access to a beverage retainer 160 that is designed and dimensioned to receive a liquid container 100 such as a bottle, can, cup, or other container. The beverage retainer 160 is coupled to a gyroscope 130 that is suspended within the upper housing 122. The gyroscope is coupled to a suspension 152. The upper housing 122 is supported by the lower housing 24, and the lower housing is designed and dimensioned to be inserted into a vehicle cup holder.

FIG. 8 shows a side view of the beverage holder 120 with the outer shell of the upper housing 122 removed, thus exposing a framework 140 within the upper housing. The framework 140 includes a plurality of rods 142 extending between an upper disc 144 and a lower disc 146. An upper end of each rod is fixed to the upper disc 144, and a lower end of each rod 142 is fixed to the lower disc 146. The complete framework, including the upper disc 144, the lower disc 146 and the rods 142, is fixed relative to the outer shell of the upper housing 122.

A plurality of springs 148 are coupled to the rods 142. In particular, one rod 142 extends axially through the center of each spring 148 such that each spring 148 is slideably coupled to a rod 142. Moreover, each spring 148 may be compressed or extended with the associated rod 142 extending through the spring. The springs 148 may not be released from the rods 142 because they are bounded on the framework 140 by the upper disc 144 and the lower disc 146. In the embodiment of FIGS. 8-10, there are two pairs of rods 142 with associated springs 148, including a first pair of rods on one side of the framework 140 and a second pair of rods on an opposite side of the framework. Two springs are associated with each of these rods 142, including an upper spring and a lower spring.

A support 150 is coupled to each pair of rods 142 such that two supports 150 are positioned 180° opposite one another on the framework 140. Each support 150 is a block-like structure including two bores, each bore configured to receive one of the rods 142. As a result, each support 150 is slideable in an axial direction 102 defined by the associated rods 142. However, even though the support 150 is moveable along the rods, the support is prevented from rotating relative to the rods because there are two rods extending through each support 150. Each support 150 is spring-biased toward an equilibrium position by the two upper springs 148 and the two lower springs 148 positioned on the associated rods 142. The two lower springs 148 bias the support 150 upwardly and prevent the support from sliding to the lower disc 146. The two upper springs 148 bias the support 150 downwardly and prevent the support from moving to the upper disc 144. The structure of the supports 150, rods 142 and springs 148 together provide a suspension 152 for the beverage holder that dampens movement of the liquid container 100 in the axial direction 102.

The gyroscope 130 is coupled to the two supports 150. The gyroscope includes an outer gimbal 132 and an inner gimbal 134. The outer gimbal 132 is rotatably coupled to the two supports 150 and is configured to rotate about a first axis of rotation 104 extending through the center of the two supports 150. The inner gimbal 134 is rotatably coupled to the outer gimbal 132 and is configured to rotate about a second axis of rotation 106 extending through the outer gimbal 132 and perpendicular to the first axis of rotation 104.

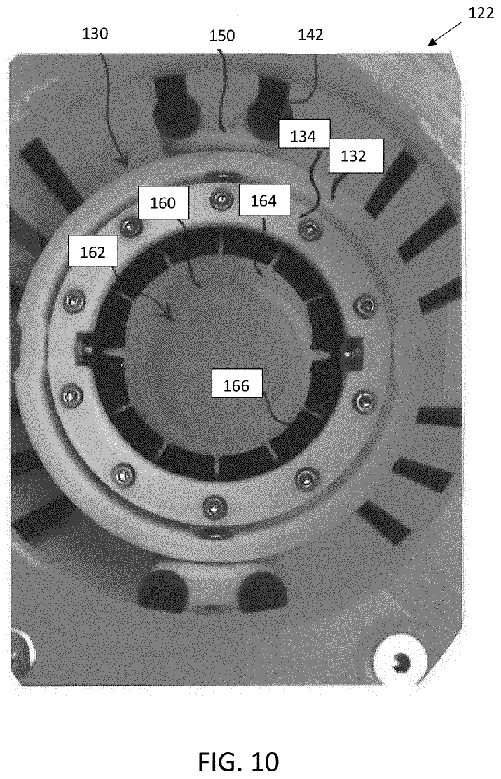

The beverage retainer 160 is coupled to the inner gimbal 134 and depends therefrom. The beverage retainer 160 includes a mouth 162 and a body 164. The mouth 162 (as best seen in FIG. 10) is designed and dimensioned to receive a standard beverage bottle, can, cup or other liquid container for a beverage (i.e., a liquid container that is designed and configured for drinking directly therefrom). Accordingly, the mouth 162 may be circular in shape and defined by a diameter between 2.5 inches and 4.0 inches, and in at least one embodiment between 2.75 and 3.25 inches. The body 164 may be provided in various forms, such as a cage structure (as shown in FIGS. 8 and 9) or a complete bowl structure (e.g., as shown in the embodiment of FIG. 2), and is configured to bear the weight of the liquid container 100. A plurality of resilient teeth 166 or other reinforcement structures may be positioned around the mouth 162 or the body 164 and configured to abut the liquid container 100 that is inserted into the beverage retainer 160, thereby supporting the liquid container and helping to keep the liquid container securely held within the beverage retainer 160. In various embodiments the reinforcement structures may be provided by plastic or foam pads, spring biased braces, or any of various other structures as will be recognized by those of ordinary skill in the art.

With reference again to FIG. 8, the upper housing 122 that holds the beverage retainer 160 is attached to a lower housing 124. The lower housing 124 is generally cylindrical in shape and defines a lesser volume than the upper housing. In particular, the lower housing is typically about 3.0 to 6.0 inches in length and defined by a diameter of between 2.75 inches and 4.0 inches, thus allowing the lower housing to fit within a typical vehicle cup holder. The lower housing 24 thus provides a base for the beverage holder 120 (accordingly, the lower housing may alternatively be referred to as a base member or lower cup). In at least some embodiments, the lower housing 124 is substantially solid and relatively heavy in weight, thus providing a solid foundation for the beverage holder 120 when it is inserted into a cup holder of a vehicle.

In operation, the lower housing 124 of the beverage holder 120 is inserted into a cup holder of a vehicle. Thereafter, a liquid container 100, such as a bottle or can containing a user's carbonated beverage, is inserted into the hole in the top of the upper housing 22 and into the beverage retainer 60. When the vehicle is operated, forces applied by the vehicle are absorbed in large part by the beverage holder 20, and the user's carbonated beverage is held upright and not exposed to excessive vibration or other forces. As a result, the liquid within the liquid container 100 does not slosh around and spill out of the container. Moreover, if the beverage is carbonated, the liquid is not aggravated to the extent that the liquid loses its carbonation.

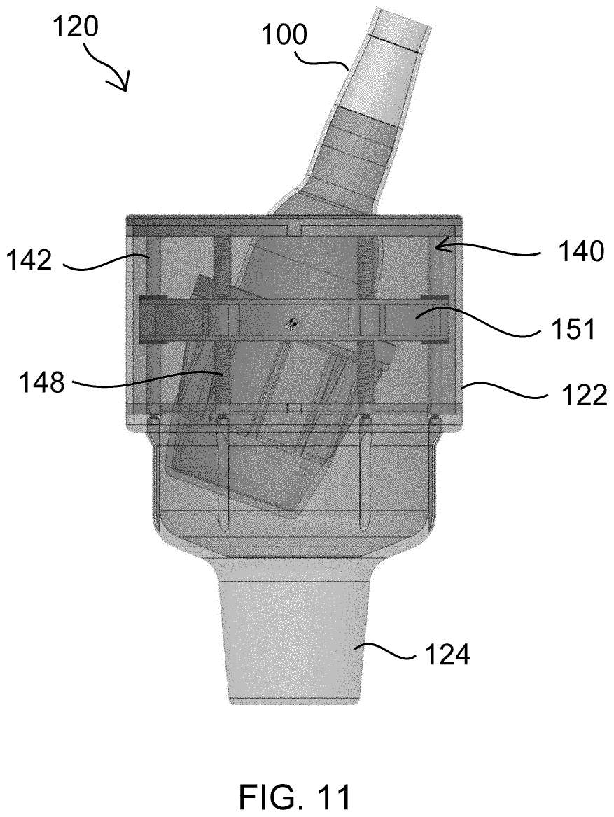

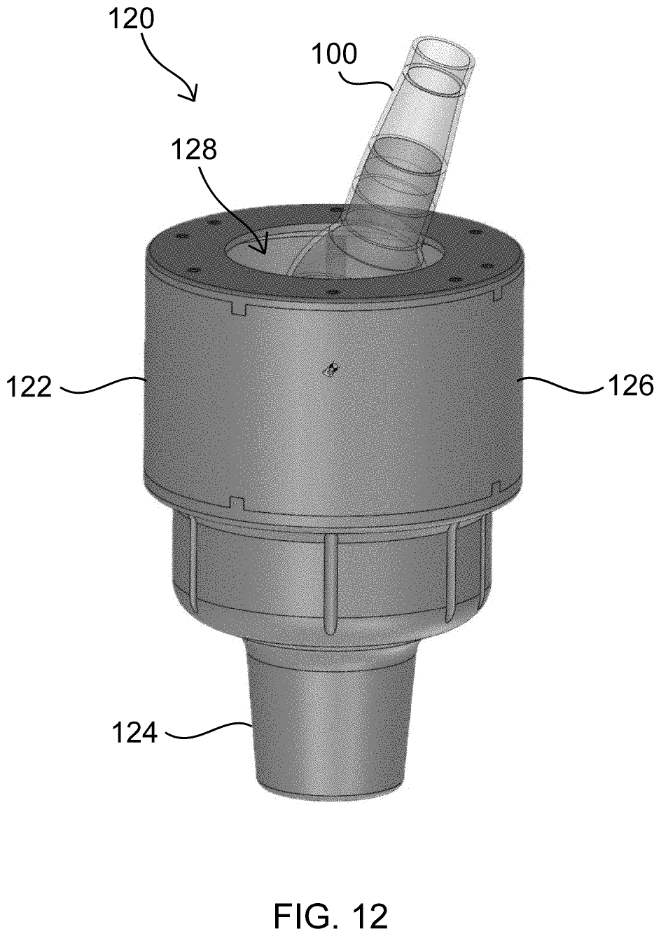

With reference now to FIGS. 11 and 12, an alternative embodiment of the beverage holder 120 is shown wherein the outer gimbal of the gyroscope and the support are combined. This embodiment is similar to the embodiment of FIGS. 8-10, however, in the embodiment of FIGS. 11 and 12, the support 150 is provided by a complete ring 151 that extends around the entire cylinder of the upper housing 122 (instead of two opposing supports on opposite sides of the upper housing 122). The ring 151 includes numerous bores that receive the rods 142. Springs 148 are provided on all or some of the rods 142 in order to spring bias the ring 151 toward an equilibrium position, similar to that described above in association with FIGS. 8-10. FIG. 11 shows the beverage holder 120 with the outer shell 126 of the upper housing 122 covering the framework on the inside of the upper housing. FIG. 11 also shows the opening 128 at the top of the upper housing 122 that is of sufficient size to receive the liquid container 100.

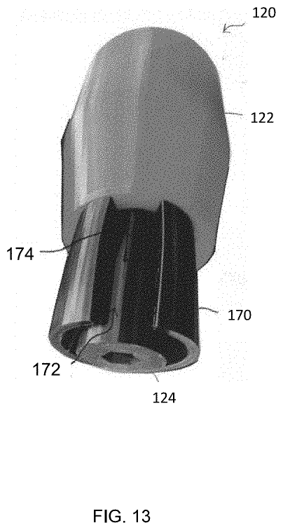

With reference now to FIG. 13, another alternative embodiment of the beverage holder is shown wherein the lower housing is wrapped with a removable sleeve 170. The removable sleeve 170 is comprised of a foam material and defines an elongated slot 172 extending from one end to another of the sleeve 170. The elongated slot 172 allows the sleeve to increase or decrease in diameter and be easily inserted onto or removed from the lower housing 124. The removable sleeve 170 is designed to be compressed onto the lower housing 124 and help secure the lower housing 124 within the cup holder of a vehicle. In particular, if the cup holder is so large that the lower housing 124 does not snugly fit therein, the removable sleeve 170 may be wrapped around the lower housing 124 and compressed into the cup holder to insure a secure fit between the cup holder and the lower housing. As best shown in FIG. 13, the lower housing 124 may include a rib 174 designed to engage the slot 172 of the removable sleeve, thus further assisting the user in securing the removable sleeve 170 in a proper position on the lower housing 124. In at least some embodiments, the lower housing 124 and the removable sleeve 170 may be conical in shape, thus providing further structure for coupling the lower housing 124 and the removable sleeve.

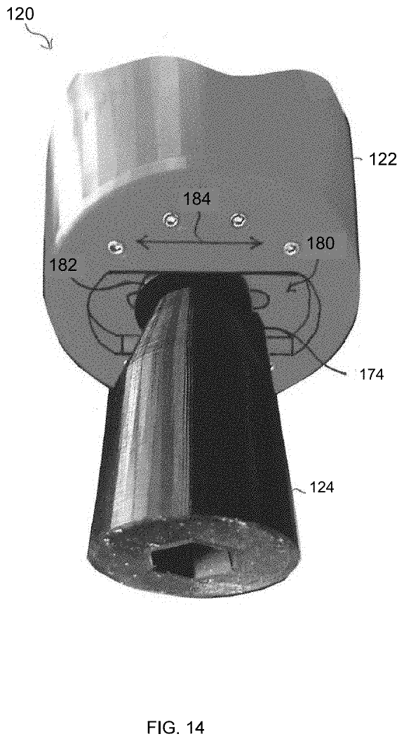

With reference now to FIG. 14, yet another alternative embodiment of the beverage holder is shown wherein the upper housing 122 is movable relative to the lower housing 124. In this embodiment, a groove 180 is formed on the lower side of the upper housing 122. An insert 182 on an upper side of the lower housing 124 is fitted within the groove 180. As shown by arrow 184, the insert is slideable back-and-forth within the groove 180 in a direction that is perpendicular to the axial direction of the beverage holder (as defined above). This allows the upper housing 122 to be positioned relative to the housing at any position between a first side of the groove 180, and a second side of the groove. Accordingly, after the lower housing 124 of the beverage holder 120 is inserted into a vehicle cup holder, the user is provided with the ability to adjust the position of the upper housing 122 to fit his or her preferred position of the beverage holder.

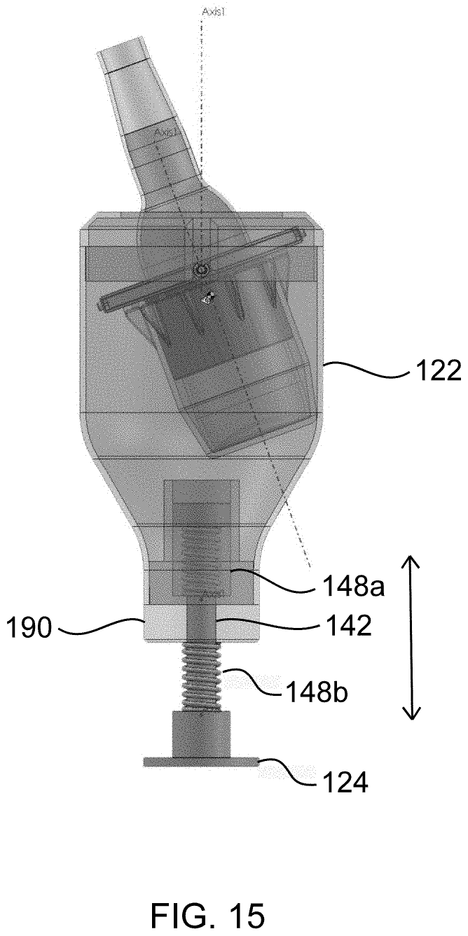

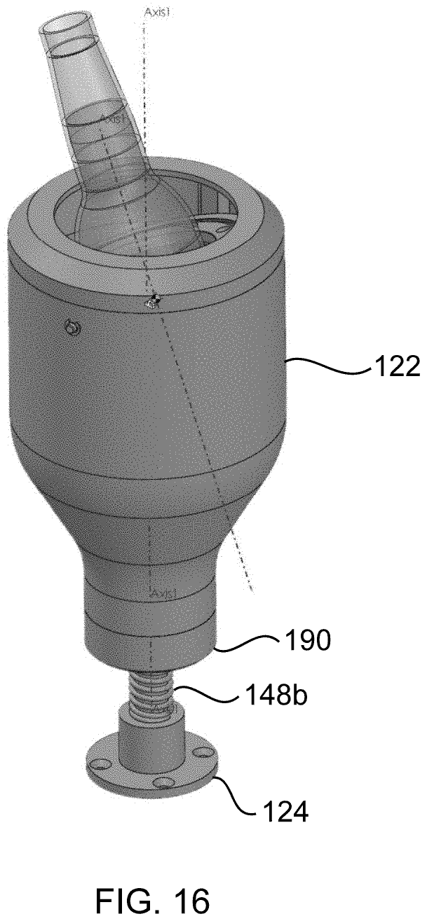

With reference now to FIGS. 15 and 16, yet another embodiment of the beverage holder is shown. In this embodiment, the upper housing 122 still retains a gyroscope, but the framework 140 of FIGS. 8-10 is removed, and a different configuration of suspension 152 is utilized. In this embodiment of FIGS. 15 and 16, the upper housing 122 is secured to a base structure (which may be considered the lower housing 124) by the suspension 152. The suspension includes a rod 142 that extends between the upper housing 122 and the base 124. Similar to the previously described suspension 152, an upper spring 148a is positioned on an upper end of the rod 142, and a lower spring 148b is positioned on the lower end of the rod 142. The upper spring 148a is positioned within a cavity of the upper housing 122, and the lower spring 148b is positioned within the base 124 (which may be similar or the same as the lower housing 24 in any of the previously described embodiments). A shelf 190 is provided at the bottom of the upper housing 122. The shelf 190 defines a bore that the rod 142 extends through. The springs 148a and 148b engage opposite sides of the shelf. In this manner, the upper housing 122 is configured to move relative to the base 124 as it slides along the rod 142. However, movement of the upper housing is limited by the springs 148a and 148b which extend and retract when forces are applied to the upper housing 122 and tend to maintain the upper housing in an equilibrium position relative to the base. While the suspension of FIGS. 15 and 16 has been described in association with one particular embodiment, it will be appreciated that the suspension of FIGS. 15 and 16 may also be applied to any of the above-described embodiments.

Several embodiments of the beverage holder have been described above with reference to FIGS. 1-16. It will be appreciated that alternate embodiments of the present disclosure and their equivalents may be devised without parting from the spirit or scope of the present disclosure. It is noted that any discussion above regarding “one embodiment”, “an embodiment”, “an exemplary embodiment”, and the like indicate that the embodiment described may include a particular feature, structure, or characteristic, and that such particular feature, structure, or characteristic may not necessarily be included in every embodiment. In addition, references to the foregoing do not necessarily comprise a reference to the same embodiment. Furthermore, irrespective of whether it is explicitly described, one of ordinary skill in the art will readily appreciate that each of the particular features, structures, or characteristics of the given embodiments may be utilized in connection or combination with those of any other embodiment discussed herein.

It will be recognized that various operations may be described herein as multiple discrete actions or operations in turn, in a manner that is most helpful in understanding the claimed subject matter. However, the order of description is not to be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the foregoing disclosure, the terms “comprising,” “including,” “having,” and the like, as used with respect to embodiments of the present disclosure, are synonymous. Furthermore, terms of reference, and particularly terms of orientation such as top, bottom, up, down, forward, rear, etc. are intended as being associated with an intended use, and are not limiting with respect to the possible orientation or arrangement of any disclosed structure.

The foregoing detailed description of one or more embodiments of the beverage holder has been presented herein by way of example only and not limitation. It will be recognized that there are advantages to certain individual features and functions described herein that may be obtained without incorporating other features and functions described herein. Moreover, it will be recognized that various alternatives, modifications, variations, or improvements of the above-disclosed embodiments and other features and functions, or alternatives thereof, may be desirably combined into many other different embodiments, systems or applications. Presently unforeseen or unanticipated alternatives, modifications, variations, or improvements therein may be subsequently made by those skilled in the art which are also intended to be encompassed by any appended claims. Therefore, the spirit and scope of any eventually appended claims should not be limited to the description of the embodiments contained herein.

What is claimed is:

1. A beverage holder configured to receive a liquid container, the beverage holder comprising:
a gyroscope including a frame member, an outer gimbal and an inner gimbal;
a beverage retainer coupled to the inner gimbal of the gyroscope, the beverage retainer designed and dimensioned to secure the liquid container therein;
a vehicle mount arranged below the gyroscope and configured to move relative to the gyroscope; and
a suspension coupling the gyroscope to the vehicle mount, the suspension including a spring arrangement configured to reduce shock and permit movement between the gyroscope and the vehicle mount.

2. The beverage holder of claim 1 further comprising a tuned mass damper coupled to the gyroscope, the tuned mass damper configured to reduce the amplitude of linear movement input into the gyroscope from the vehicle mount.

3. The beverage holder of claim 2 wherein the spring arrangement includes a plurality of flat springs arranged on at least one plate, the at least one plate further including an outer rim and an inner rack with the plurality of flat springs extending between the outer rim and the inner rack, wherein the outer rim is connected to the vehicle mount and the inner rack is connected to the frame member of the gyroscope, and wherein the plurality of flat springs are configured to permit linear movement between the outer rim and the inner rack and also bias the outer rim and the inner rack to an equilibrium position.

4. The beverage holder of claim 1 wherein the spring arrangement includes a plurality of compression springs extending between the frame member of the gyroscope and the vehicle mount.

5. The beverage holder of claim 4 further comprising a plurality of posts connected to the vehicle mount, wherein the compression springs are retained on the vehicle mount by the plurality of posts.

6. The beverage holder of claim 1 wherein the frame of the gyroscope is directly coupled to a housing that is moveable relative to the vehicle mount.

7. The beverage holder of claim 6 wherein the vehicle mount includes a cup wall, an interior chamber formed within the cup wall, and a center post extending through the interior chamber, wherein the housing includes a center tube extending from a bottom of the housing, and wherein the center post of the vehicle mount extends into the center tube.

8. The beverage holder of claim 1 wherein the inner gimbal is a disk having an outer diameter and an inner diameter, wherein the inner diameter is between 6 cm and 8 cm, and wherein a plurality of resilient plastic teeth extend inwardly from the inner diameter.

9. The beverage holder of claim 8 wherein a beverage cup depends from the inner gimbal such that the beverage cup is pivotable with respect to the outer gimbal.

10. The beverage holder of claim 1 wherein the spring arrangement biases the gyroscope and the vehicle mount toward an equilibrium position.

11. A beverage holder for a vehicle having a vehicle cup holder, the beverage holder configured to receive a liquid container therein, the beverage holder comprising:
a gyroscope including a support member, an outer gimbal and an inner gimbal, the outer gimbal pivotably coupled to the support member, and the inner gimbal pivotably connected to the outer gimbal;
a beverage retainer coupled to the inner gimbal of the gyroscope, the beverage retainer designed and dimensioned to secure the liquid container therein;
a vehicle mount, the vehicle mount including a substantially cylindrical portion designed and dimensioned for insertion into a vehicle cup holder; and
a suspension providing a moveable coupling that permits axial movement between the gyroscope support member and the vehicle mount.

12. The beverage holder of claim 11, wherein the suspension includes a spring arrangement permitting linear movement between the gyroscope support member and the vehicle mount.

13. The beverage holder of claim 12 wherein the spring arrangement is provided by a plate member defining an outer rim, a center bracket, and a plurality of flat springs extending between the outer rim and the center bracket.

14. The beverage holder of claim 12 wherein the spring arrangement includes at least one compression spring extending between the gyroscope support member and the vehicle mount.

15. A beverage holder configured to receive a liquid container, the beverage holder comprising:
a housing including an upper housing and a lower housing, the lower housing designed and dimensioned to fit within a vehicle cup holder, the upper housing including an opening designed and dimensioned to receive the liquid container, the upper housing defining a greater volume than the lower housing;
a suspension positioned within the upper housing, the suspension including a plurality of rods, a plurality of springs coupled to the plurality of rods, and a support slideably coupled to the plurality of rods, wherein the support is biased by the plurality of springs and configured to move along the plurality of rods in an axial direction;
a gyroscope positioned within the upper housing and coupled to the support of the suspension, the gyroscope including an outer gimbal rotatably attached to an inner gimbal; and
a beverage retainer coupled to the inner gimbal, the beverage retainer configured to receive and retain the liquid container therein.

16. The beverage holder of claim 15 wherein the outer gimbal is rotatably coupled to the support, the support including a first support member positioned one side of the gyroscope and a second support member positioned on an opposite side of the gyroscope, the first support slideable relative to a first rod, and the second support slideable relative to a second rod, wherein the plurality of springs includes a first upper spring coupled to an upper side of the first rod, a first lower spring coupled to a lower side of the first rod, a second upper spring coupled to an upper side of the second rod, and a second lower spring coupled to a lower side of the second rod, wherein the first support member is positioned between the first upper spring and the first lower spring, and wherein the second support member is positioned between the second upper spring and the second lower spring.

17. The beverage holder of claim 15 wherein the upper housing defines a greater volume than the lower housing, wherein the upper housing is slideably coupled to the lower housing such that the upper housing is configured to move relative to the lower housing in a direction perpendicular to the axial direction.

18. The beverage holder of claim 15 wherein the beverage retainer is a cage structure depending from the inner gimbal.

19. The beverage holder of claim 15 wherein the beverage retainer is a bowl depending from the inner gimbal.

20. The beverage holder of claim 15 wherein the retainer includes a plurality of adjustable reinforcement structures configured to abut the liquid container when it is inserted into the retainer.
